(19) United States
(12) Patent Application Publication
(10) Pub. No.: US 2026/0258563 A1
(43) Pub. Date: Sep. 3, 2026

(54) OPERATING AN ELECTROCHEMICAL CELL IN THE CONTEXT OF PROCESSING LITHIUM-CONTAINING WATER

(71) Applicant: Evonik Operations GmbH, Essen (DE)

(72) Inventors: Christian Hying, Rhede (DE); Elisabeth Gorman, Haltern am See (DE); Meike Dahlhues, Marl (DE); Nicole Decker, Bochum (DE); Patrik Stenner, Hanau (DE); Tobias Stadtmüller, Seligenstadt (DE); Sebastian Arndt, Ginsheim Gustavsburg (DE)

(21) Appl. No.: 19/155,983

(22) PCT Filed: Feb. 5, 2024
(86) PCT No.: PCT/EP2024/052743

§ 371 Date: Aug. 13, 2025

(30) Foreign Application Priority Data
Feb. 15, 2023 (EP) 23156686.0

(51) Int. Cl. C25B 9/21; C02F 1/469; C25B 1/04; C25B 1/16; C25B 13/07; C25B 13/08; C25B 15/00

(52) U.S. Cl. CPC C25B 9/21; C02F 1/4693; C25B 1/04; C25B 1/16; C25B 13/07; C25B 13/08; C25B 15/00; C02F 2201/46115

(57) ABSTRACT

The invention relates to the operation of an electrochemical cell (0) for the purpose of processing lithium-containing waters. It is based on the object of operating the cell (0) with better current yield in order to keep its permeance constant and to improve the purity of the target product (LiOH). An essential aspect of the process according to the invention is that it is carried out in a three-chamber cell having an anode separator (3) and a cathode separator (4). A basic idea of the process according to the invention is to use an inorganic cathode separator (4) having an ion selectivity in favour of lithium. This has the result that fewer cationic impurities (Me^{m+}) are able to be converted into unwanted byproducts, which increases the current yield and improves the purity of the target product (LiOH). The anode separator (2) is anion-conducting. A further, essential aspect of the operation according to the invention is that two electrochemical processes are carried out simultaneously, namely on the one hand a membrane-supported electrodialysis of ions and on the other hand an electrolysis of water.

The invention relates to the operation of an electrochemical cell for the purpose of processing lithium-containing waters.

Lithium-containing waters are mixtures containing predominantly water and lithium compounds dissolved therein. Other dissolved substances may also be present therein, for instance sulfates, hydrogensulfates, carbonates, hydrogencarbonates, hydroxides, chlorides or fluorides of the following elements: B, Na, Mg, Al, Si, K, Ca, Mn, Fe, Co, Ni, Cu. In addition, lithium-containing waters may also contain organic compounds.

Lithium-containing waters occur naturally, for example as Li brine in salt lakes, as seawater or as groundwater. In addition, lithium-containing waters occur in deep boreholes or as mine water. Finally, lithium-containing waters are also produced in the recycling of used lithium-ion batteries (LIB) and in the production of new LIBs. The origin of the lithium-containing waters thus varies, and therefore so does their composition: not only can the Li concentration vary considerably, but also the amount and type of the other dissolved substances.

Lithium-containing waters are used as a starting material for the obtaining of lithium-containing compounds, such as in particular of lithium carbonate (Li₂CO₃) or lithium hydroxide (LiOH). Both are needed for the production of LIBs. Due to the sharp increase in the demand for new LIBs and the increasing amount of used LIBs, numerous processes for processing lithium-containing waters have been developed which are usually aimed at obtaining lithium carbonate (Li₂CO₃) or lithium hydroxide (LiOH) with the greatest possible purity. The processes have been optimized on the one hand in terms of the desired target compound and on the other hand in terms of the composition of the lithium-containing water used. An overview is given in:
Wietelmann, U. and Steinbild, M. (2014). Lithium and Lithium Compounds. In Ullmann's Encyclopedia of Industrial Chemistry, (Ed.). DOI: 10.1002/14356007.a15_393.pub2.

Such processing processes that predominately operate thermally or with crystallization effects are prevalent commercially, particularly when obtaining primary lithium from salt lakes. This is very resource-intensive in many respects.

For this reason, newer processes have since been developed for obtaining lithium compounds from lithium-containing waters that operate using electrical energy. These processes are electrochemical processes, particularly electrolysis or electromembrane dialysis. The fundamental advantage of these electrochemical processes is that they are very resource-friendly when using green electricity.

A disadvantage is that the complex apparatus technology, particularly the electrochemical cells in which the processing takes place, is very demanding in terms of material science.

A selection of electrochemical processes for the separation of lithium from waters from the recycling of used batteries or seawater has been compiled:
Pankaj K. Choubey et al.: Advance review on the exploitation of the prominent energy-storage element Lithium. Part II: From sea water and spent lithium ion batteries (LIBs), Minerals Engineering, Volume 110, 2017, Pages 104-121, DOI: 10.1016/j.mineng.2017.04.008.

In section 2.2, Choubey et al describe modern electrodialytic processes which are carried out in electrochemical cells that are each equipped with two different ion-conducting membranes, namely with an anion-conducting membrane and a cation-conducting membrane. The desired ion conductivity of the membranes is achieved by impregnation with an ionic liquid.

CA 3077834 A1 describes a process for preparing high-purity lithium hydroxide from heavily contaminated sources such as brines from salt lakes. A complex interconnection of different purification stages is disclosed, which also include an electrodialysis with a three-chamber cell equipped with a bipolar membrane. A bipolar membrane is the combination of an anion exchange membrane and a cation exchange membrane. The chemical nature of these membranes is not disclosed in CA 3077834 A1.

EP 2 841 623 B1 discloses a process for preparing lithium hydroxide using an electrochemical cell having three compartments and two separators (what is known as a three-chamber cell). The three-chamber process known from EP 2 841 623 B1 involves supplying an aqueous stream containing lithium sulfate to the central compartment of the three-chamber cell. Lithium hydroxide is introduced into the cathodic compartment, while ammonia water is fed into the anodic compartment. An aqueous solution containing lithium hydroxide is withdrawn from the cathodic compartment of the cell, and ammonium sulfate is formed in the anodic compartment. In addition, oxygen is formed on the anodic side and hydrogen is formed at the cathode. The three-chamber cell is operated under basic conditions.

The three-chamber cell known from EP 2 841 623 B1 fundamentally has two membranes which separate the central compartment from the anodic compartment and the cathodic compartment. Materials including perfluorinated polymers and styrene or divinylbenzene membranes are considered as membrane materials. In particular, use should be made of cation-exchange membranes or PEEK-reinforced membranes. Examples mentioned are the commercial ion-exchange membranes Asahi AAV, Fumatech FAB, Astrom Neosepta® or Lanxess Ionac®. The chemical nature of these ion-exchange membranes is not disclosed in EP 2 841 623 B1, but it is highly likely that they are organic membrane materials.

A fundamental drawback of polymer membranes is their permeability to water. This results in dilution of the anolyte with water from the catholyte. Furthermore, organic ion-exchange membranes allow not just Li⁺, but also Na⁺ to pass through, thereby impairing the purity of the target product if Na is also present in the starting material. In addition to the purity of the target product, the current yield of the process also suffers: When the electrolysis is carried out using organic membranes, the transport of unwanted Na⁺ into the second compartment also consumes valuable electrical energy. Moreover, on reaching the second compartment, the Na⁺ is converted into unwanted byproducts by means of unintended electrochemical processes. The energy efficiency of the process based on the yield of the target product Li is reduced. Lastly, these membranes are sensitive to the presence of divalent cations such as Mg²⁺ and Ca²⁺. These cations poison the membrane over time, with the result that its conductivity for lithium is reduced: This manifests itself in the fact that the permeance of the membrane, i.e. its area-based Li conductivity based on its thickness, decreases. This means that less lithium is able to be precipitated from the lithium-containing water. The reduction in current efficiency, increasing contamination of the target product with foreign cations and decreasing permeance result in the operation of the electrochemical cell quickly becoming uneconomical.

With regard to this prior art, the present invention is based on the object of operating the electrochemical cell with better current yield in order to keep its permeance constant and to improve the purity of the target product.

This object is achieved by operating the electrochemical cell as follows:
a) At least one electrochemical cell having at least the following features is provided:
   i) the electrochemical cell comprises an anode and a cathode;
   ii) the electrochemical cell comprises a cathode separator and an anode separator;
   iii) the electrochemical cell comprises an anodic compartment, a central compartment and a cathodic compartment;
   iv) the cathode separator separates the central compartment from the cathodic compartment;
   v) the anode separator separates the central compartment from the anodic compartment;
   vi) the cathode separator comprises an inorganic material which is electrically insulating and has a conductivity for anions and a conductivity for cations, the conductivity for cations being greater than the conductivity for anions and the conductivity for Li cations (Li⁺) being greater than the conductivity for cationic impurities (Me^{m+});
   vii) the anode separator comprises an organic material having a conductivity for anions (Xⁿ⁻, OH⁻) and a conductivity for cations, the conductivity for anions (Xⁿ⁻, OH⁻) being greater than the conductivity for cations;
   viii) the inorganic material and/or the organic material is electrically insulating;
b) A catholyte is provided in the cathodic compartment, the catholyte comprising at least: water (H₂O), Li cations (Li⁺), hydroxide ions (OH⁻);
c) A central electrolyte is provided in the central compartment, the central electrolyte comprising at least: water (H₂O), Li cations (Li⁺), anions (Xⁿ⁻) and cationic impurities (Me^{m+});
d) An anolyte is provided in the anodic compartment, the anolyte comprising at least: water (H₂O) and anions (Xⁿ⁻);
e) At least one electrical voltage source is provided which can be connected to the anode via a first electrical lead and to the cathode via a second electrical lead;
f) An electrical voltage U obtained from the electrical voltage source is applied to the electrochemical cell such that an electrical current/flows between the anode and cathode.

A basic idea of the process according to the invention is to use an inorganic cathode separator having an ion selectivity in favour of lithium. This means that the material from which the cathode separator is produced has a higher conductivity for Li⁺ cations than for other cations such as Nat or other cationic impurities Me^{m+}. This has the result that fewer cationic impurities are able to pass into the cathodic compartment and be converted there into unwanted byproducts, which increases the current yield and improves the purity of the target product.

What are known as LiSICons are preferably used as inorganic material having a higher conductivity for Li⁺ than for other cations. LiSICon stands for lithium super ionic conductor. This is a class of inorganic, (glass-) ceramic material which is electrically insulating, but at the same time has an intrinsic conductivity for Li ions. The transport mechanism for Li derives from the crystal structure of the material. The Li ions are—in simplified terms—“passed through” the crystals. Commercially available LiSICon materials include lithium aluminium titanium phosphate (LATP), lithium aluminium titanium silicon phosphate (LATSP), lithium aluminium germanium phosphate (LAGP) and lithium lanthanum titanium oxide (LLTO). These materials were originally developed as solid-state electrolytes for LIBs. An overview of the transport mechanisms of LiSICons, their crystal structure and production is given in:
Palakkathodi Kammampata et al.: Cruising in ceramics—discovering new structures for all-solid-state batteries—fundamentals, materials, and performances. Ionics 24, 639-660 (2018) DOI: 10.1007/s11581-017-2372-7.
Yedukondalu Meesala et al.: Recent Advancements in Li-lon Conductors for All-Solid-State Li-lon Batteries. ACS Energy Lett. 2017, 2, 12, 2734-2751 DOI: 10.1021/acsenergylett.7b00849.

Specific LiSICon stoichiometries are described by:
Sofia Saffirio et al. Li_{1.4}Al_{0.4}Ge_{0.4}Ti_{1.4} (PO₄)₃ promising NASICON-structured glass-ceramic electrolyte for all-solid-state Li-based batteries: Unravelling the effect of diboron trioxide, Journal of the European Ceramic Society, volume 42, issue 3, 2022, pages 1023-1032 DOI 10.1016/j.jeurceramsoc.2021.11.014.
Eongyu Yi et al. Materials that can replace liquid electrolytes in Li batteries: Superionic conductivities in Li_{1.7}Al_{0.3} Ti_{1.7}Si_{0.4}P_{2.6}O₁₂. Processing combustion synthesized nanopowders to free standing thin films. Journal of Power Sources, volume 269, 2014, pages 577-588, DOI 10.1016/j.jpowsour.2014.07.029.

Their selective conductivity for Li ions means that LiSICon materials can be used as a membrane for separating lithium from Li-containing mixtures. The lithium must be present in the mixture in ionic form, for instance as an Li salt dissolved in water.

It is known in principle from the prior art to use LiSICon for separating lithium from aqueous streams:

For example, WO 2019055730 A1 roughly describes the selective obtaining of lithium on an LiSICon membrane.

In WO 2022157624 A1, use is made of a three-chamber cell LLTO membrane for the electrodialysis of seawater for the purpose of obtaining lithium.

US2012103826 A1 describes both a two-chamber cell with an LiSICon membrane, and a three-chamber cell having compartments that are separated with an organic cation exchange membrane and an organic anion exchange membrane. The cells are used to obtain lithium products.

An essential aspect of the process according to the invention is that it is carried out in a three-chamber cell. While an electrochemical cell in the simplest construction comprises only two compartments separated from one another by exactly one separator, a three-chamber cell has two separators which divide the cell into three compartments. Reference is made herein to an anode separator and a cathode separator in order to differentiate the two separators. The anode separator is arranged on the anode side, while the cathode separator is installed on the cathode side. The essential components of a three-chamber cell are therefore an anode, an anode separator, a cathode separator and a cathode. The first, anodic compartment is formed between the anode and anodic separator. The second, cathodic compartment is formed between the cathodic separator and cathode. The third compartment is created centrally between the anodic separator and cathodic separator and is therefore called the central compartment.

In addition to the fundamental functional elements mentioned, the electrochemical cell according to the invention may additionally also contain further components, for instance catalysts for accelerating the water electrolysis, porous transport layers (PTL), flow fields (FF) for transporting the electrolytes or spacers. Furthermore, the individual functional elements may also be combined to form integrated components, for instance to form membrane electrode assemblies (MEA). It is also possible to connect multiple electrochemical cells to one another to form an aggregate, for instance by way of a series connection or parallel connection. In the case of a series connection, the anode of the one cell can be in direct electrical contact with the cathode of the neighbouring cell and vice versa. Directly contacted electrodes of different polarity can also be combined in a bipolar plate.

In addition to the solid functional elements listed, the electrochemical cell also comprises liquid electrolyte that is needed for the operation of the cell. In the present case, the electrolyte filled into the anodic compartment is called anolyte, while the electrolyte present in the cathodic compartment is called catholyte. The anolyte is therefore in contact with the anode, while the catholyte is contacted with the cathode. The electrolyte present in the central compartment is called central electrolyte herein. It is separated from the two electrodes by the two separators.

In principle, the electrochemical cell is operated according to the invention as follows: The central electrolyte serves as a feed for the process; it comprises the lithium cations which are part of the target product. The central electrolyte is fed from the lithium-containing water to be processed. The target product is synthesized at the cathode. The target product is consequently found in the catholyte. The anolyte serves as a sink for anionic impurities, against which the cathode separator is protected according to the invention.

A further, essential aspect of the process according to the invention is that two electrochemical processes are carried out simultaneously, namely on the one hand a membrane-supported electrodialysis of ions and on the other hand an electrolysis of water.

The electrodialysis serves on the one hand to enrich the Li cations Li⁺ present in the central electrolyte in the catholyte. Furthermore, the anionic impurities Xⁿ⁻ present in the feed are electrodialytically enriched in the anolyte in order to prevent the impurities from coming into contact with the cathode separator. In this way, the cathode separator is protected from being poisoned by the anionic impurities Xⁿ⁻. To make this possible, the anode separator is anion-conductive.

In parallel, in the process according to the invention water is electrochemically split (electrolysis) into hydrogen and oxygen. The hydroxide ions OH— formed as intermediate during the water splitting combine in the catholyte with the Li+ cations enriched therein to form lithium hydroxide (LiOH) or its monohydrate (LiOH·H₂O), the desired target product.

The particular advantage of the combination according to the invention of an anion-exchange membrane as anode separator with an inorganic ion-selective LiSICon membrane as cathode separator is that the anion-exchange membrane protects the LiSICon membrane against the detrimental influence of the anions such as sulfate, carbonate, hydroxide, chloride and fluoride that are present in the feed. These anions are transferred into the anodic compartment namely via the organic anion-exchange membrane, with the result that they cannot damage the LiSICon membrane. The service life of the LiSICon material used as cathode separator is significantly improved as a result; in particular if the feed contains a large amount of anionic impurities. The latter is especially the case if a lithium-containing water originating from the recycling or the production of lithium-ion batteries is used as feed.

The process according to the invention is preferably carried out continuously. This means that at least the provision of the flowable components, namely the electrolytes and the electrical current, is performed permanently. The provision of the non-flowable components such as cell and voltage source is always permanent in any case, even if these components only have to be provided once. The individual process steps of the operation are performed simultaneously in the continuous process.

Preferably, the process is carried out partially in a basic medium. More precisely, basic conditions should exist in the central electrolyte and in the catholyte. This means that more hydroxide ions (OH—) are additionally present in the central electrolyte. The pH of the central electrolyte should be between 9 and 12, measured using a glass electrode at a temperature of 25° C. If it is not in this range, lithium-containing waters used as central electrolyte must have their pH adjusted before the treatment. The basicity of the central electrolyte is important because the LiSICon membrane materials used have the greatest stability under these conditions. Acidic conditions result in damage to the materials over relatively long operating times and must therefore be avoided.

The anolyte is preferably strongly acidic, or the pH of the anolyte is continuously reduced by at least one of the anode reactions, the formation of protons, and often reaches a pH of less than 4, measured using a glass electrode at a temperature of 25° C.

The anions present in the central electrolyte are specifically sulfate or hydrogensulfate or carbonate or hydrogencarbonate or hydroxide or chloride or fluoride. These anions are regularly found in lithium-containing waters and thus also in the central electrolyte. Said central electrolyte has a higher concentration of the anions just mentioned than the hydroxide ions.

The cationic impurities also present in the central electrolyte are specifically cations of the following elements: B, Na, Mg, Al, Si, K, Ca, Mn, Fe, Co, Ni, Cu, C. These are also often found in lithium-containing waters. The alkali and alkaline earth metals occur in particular in lithium-containing brines of natural origin, while the metal cations are in particular found in lithium-containing waters originating from the processing of used LIBs or from production waste of LIB production. Such streams often also contain carbon compounds originating from adhesives, binders, the anode materials of the LIBs, from carbon blacks or the plastic packaging of the LIBs. These may then contain carbon-containing acids or the cations of these, but also uncharged organic decomposition products from the upstream steps of the LIB recycling.

According to the invention, the cathode separator is lithium-selective; this means that it conducts Li cations better than other cations. The specific Li⁺ conductivity σ of the inorganic material used as cathode separator should be at least 1*10⁻⁵ S/cm or better at least 5*10⁻⁵ S/cm or even better at least 10*10⁻⁵ S/cm and at most 100*10⁻⁵ S/cm. The spec. ion conductivity σ is measured by impedance spectroscopy. The temperature-dependent value should be measured at 23° C. The impedance spectroscopy takes place as follows:

The measurement setup comprises two cylindrical electrodes, with the sample arranged therebetween. To ensure optimal contact with the electrodes and reproducible contact pressure, a weight is placed on the sample.

A potentiostat (Zahner-Elektrik I. Zahner-Schiller GmbH & Co. KG, Kronach-Gundelsdorf, Germany) is connected to the electrodes and controlled via the Thales software (Zahner). The measurements are carried out in a frequency range from 1 Hz to 4 MHz and at an amplitude of 5 mV using samples that had been polished and sputtered onto a thin conductive gold layer.

The results of the measurements are presented in the form of Nyquist plots and evaluated using the analysis software (Zahner). The electrical resistance is read at the maximum of the curve of the Nyquist plot. The specific ion conductivity σ [mS/cm] is then calculated using the formula σ=(h·10⁴)/(R·π/4·d²), where h is the height of the sample in mm, R the measured electrical resistance in Q and d the diameter of the sample in mm.

Said Li selectivity and conductivity is achieved by most LiSICon materials. The cathode separator is therefore preferably produced using LiSICon material or contains an LiSICon or even completely consists of an LiSICon.

Specifically, the following LiSICons are useful:
LATP with the following stoichiometry: Li₁₊ₓAlₓTi₂₋ₓ(PO₄)₃
in which: 0.1≤x≤0.3, where preferably x=0.3.
LATSP with the following stoichiometry: Li_{1+x+y}AlₓTi₂₋ₓSi_{y}P_{3-y}O₁₂
in which: 0.1≤x≤0.3 and 0.2≤y≤0.4.
LAGTSP with the following stoichiometry: Li_{1+x+y}AlₓTi₂₋ₓSi_{y}P_{3-y}O₁₂*nGeO₂
in which: 0≤x≤1 and 0≤y≤1 and 0≤n≤1
LAGTP with the following stoichiometry: Li_{1.4}Al_{0.4}(Ge₁₋ₓTiₓ)_{1.6}(PO₄)₃
in which: 0≤x≤1.
LAGP with the following stoichiometry: Li₁₊ₓAlₓGe₂₋ₓ(PO₄)₃
in which: x=0 or x=0.2 or x=0.4.
LLTO with the following stoichiometry: Li₃ₓLa_{(2/3)-x□(1/3)-2x}TiO₃
in which: 0≤x≤0.16.
Doped LLZO with the following stoichiometry: Li_{6.4}La₃Zr_{1.4}M_{0.6}O₁₂
where M is selected from the group consisting of the following elements: Ta, Sb, Nb.
Undoped LLZO with the following stoichiometry: Li₇La₃Zr₂O₁₂.

LiSICons are commercially available, for example the LAGP Ampcera™ from MSE Supplies®, Tucson, USA.

The material from which the anode separator is produced or which it contains is an anion-conductive organic material. Such materials are also often referred to as ionomer. This is preferably a polymer having a backbone to which at least one cationic functional group is bonded. The latter is preferably quaternized trialkylammonium salt. The backbone used is preferably polystyrene, polysulfone, poly(ethersulfone) or poly(phenylene oxide), polyvinylidene fluoride, or polytetrafluoroethylene. Very particularly preferably, the quaternized trialkylammonium salt is attached to a backbone composed of polystyrene, polysulfone, poly(ethersulfone) or poly(phenylene oxide) via a benzyl(methyl) group. The anion-conductive polymer thus obtained is used in the production of the anode separator, is present in the anode separator or the anode separator completely consists of this polymer.

Such polymers are commercially available. Examples to be mentioned are: Fumasep FAPQ from Fumatech, Neosepta membranes from ASTOM, Selemion membranes from AGC, and AHA membrane from Eurodia Industrie SAS.

In a preferred embodiment of the invention, an electrochemical cell having an auxiliary cathode is used. The auxiliary cathode is contacted with the central electrolyte and connected to the electrical voltage source via a third electrical lead.

The electrochemical cell equipped with the auxiliary cathode accordingly has the following features:
ix) the electrochemical cell comprises an auxiliary cathode;
x) the auxiliary cathode is in contact with the central electrolyte;
xi) the auxiliary cathode can be connected to the electrical voltage source via a third electrical lead.

The auxiliary cathode opens up the possibility of operating the cell in particularly preferred modes of operation which are characterized by different operating states.

In a first variant, the operation has at least two operating states, namely:
p) a production state in which the anode and the cathode are connected to the electrical voltage source via the first and the second electrical lead, respectively, and in which the electrical voltage U is applied to the anode and cathode so that the electrical current/flows between the anode and cathode;
r) a regeneration state in which the anode and the auxiliary cathode are connected to the electrical voltage source via the first and the third electrical lead, respectively, and in which the electrical voltage U is applied to the anode and auxiliary cathode so that the electrical current/flows between the anode and auxiliary cathode.

In the production state, the Li is separated off from the central electrolyte and the LiOH is formed; in the regeneration state, the cathode separator is regenerated. This involves flushing the cathode separator free of metal ions that cannot pass through this separator and are concentrated on the surface, since the electrical voltage that is no longer present no longer hinders the removal. The membrane surface is therefore cleaned of impurities, with the result that the original permeance and permeability are largely restored.

According to a preferred embodiment of the first operation variant, there is an alternating change between the two operating states (production/regeneration). The regeneration phase here is significantly shorter than the production phase. Specifically, the duration of the production state t_{P} should last more than 10 or even more than 100 times as long as the duration of the regeneration state t_{R}. Thus
t_{P}>f*t_{R} where f is greater than 1 or where f is greater than 10 or where f is greater than 100.

Instead of only switching on the auxiliary cathode temporarily, it is also possible to leave the auxiliary cathode switched on permanently, so that a combined production/regeneration state is carried out. In this second variant of a mode of operation, the auxiliary cathode is dimensioned so as to be smaller than the actual cathode in terms of area. Specifically, the auxiliary cathode area A_{AK} should be selected such that A_{K}>f. A_{AK} where f is greater than 1 or where f is greater than 10 or where f is greater than 100. The area A_{K} here is the area of the cathode. The area factor f corresponds here to the time factor f of the alternating mode of operation.

In the combined production and regeneration state, the anode is connected to the electrical voltage source via the first electrical lead and the cathode and the auxiliary cathode are connected to the electrical voltage source via the second electrical lead and the electrical voltage U is applied to the anode and cathode and auxiliary cathode so that the electrical current I flows between the anode and cathode and auxiliary cathode.

The advantage of the combined production and regeneration state is that the means for switching the production states (switching relay) can be omitted. A disadvantage is that the ratio f cannot be changed so easily.

Also advantageous is a third mode of operation having two operating states, namely a combined production and regeneration state and a pure production state. This involves an alternating change between the production state (p) and the combined production and regeneration state (k), where an individual production state (p) is carried out over a duration of t_{P} and where an individual combined production and regeneration state (k) is carried out over a duration of t_{K}, where

$${t}_{P >} g * {t}_{K}$$

where g is greater than 50 or where g is greater than 500 or where g is greater than 5000.

The factor g is significantly higher here than in the two other modes of operation (factor f). This has the result that the production operation is particularly long. The productivity of the electrochemical cell is thus increased in the long term.

The auxiliary cathode is preferably arranged outside the central compartment. It then does not take up any space within the cell and does not interfere with the exchange of the ions. It is sufficient if the auxiliary cathode is in contact with the central electrolyte. Surprisingly, it is sufficient to place the auxiliary cathode in the reservoir vessel of the central electrolyte or in the supply line of the central electrolyte.

The auxiliary electrode preferably consists of a textile material. These include linear textile structures such as threads, yarns, wires or fibres and textile fabrics such as woven fabrics, weft knits, warp knits, laid scrims, felts or nonwovens. The textile material must be electrically conducting and cathodically active. This is achieved for instance with nickel-containing materials. In the simplest case, a nickel-containing, stainless steel is used as material for the auxiliary cathode. Pure nickel may also be used. The material is used in the simplest case as a wire or as a wire mesh. It is of course also possible to use pure titanium or relatively high quality electrode material, such as Ti, Pt, Nb or the like.

When the electrochemical cell is operated according to the invention, there is, according to the electrochemical model concept, an electrolysis of water and an electrodialysis of anions. This becomes apparent through the formation of oxygen at the anode and hydrogen at the cathode, and through the depletion of the anions in the central electrolyte and their enrichment in the anolyte. Furthermore, the operation according to the invention results in an electrochemical synthesis of lithium hydroxide and/or lithium hydroxide monohydrate at the cathode. These target products can be separated off from the catholyte or even precipitate therein on their own. All of this happens simultaneously.

The operation described here of an electrochemical cell preferably comprises an electrolysis of water (H₂O) and an electrodialysis of anions (Xⁿ⁻). Particularly preferably, the operation also comprises a synthesis of lithium hydroxide and/or lithium hydroxide monohydrate (LiOH·H₂O).

The process according to the invention is now to be explained in more detail on the basis of exemplary embodiments. To this end:

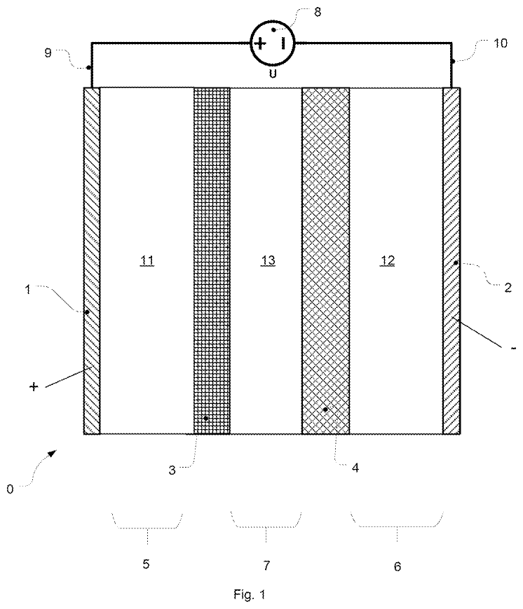

FIG. 1: shows the basic construction of a three-chamber cell;

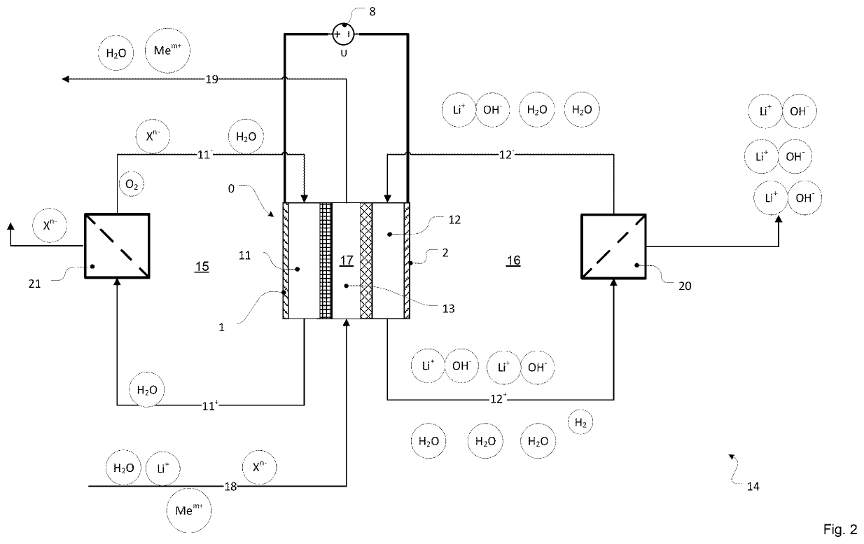

FIG. 2: shows an apparatus with a three-chamber cell in continuous operation;

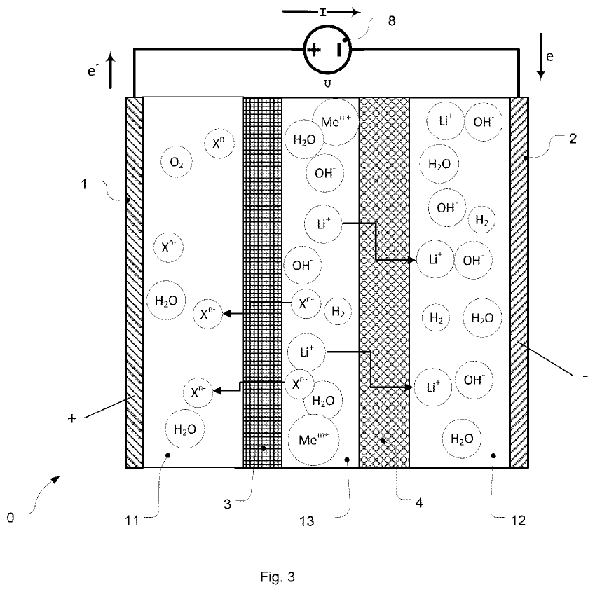

FIG. 3: shows membrane dialysis in operation;

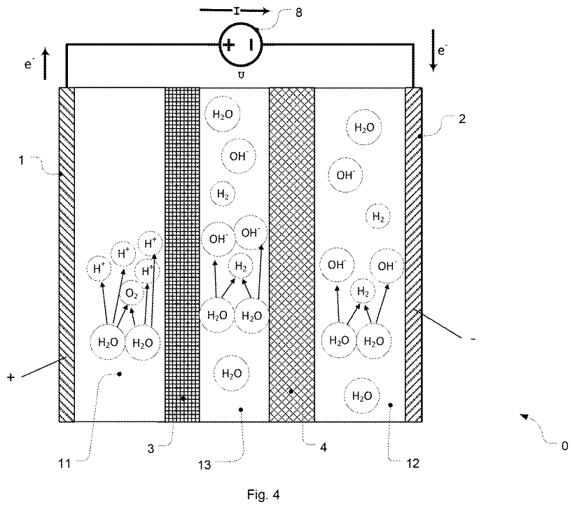

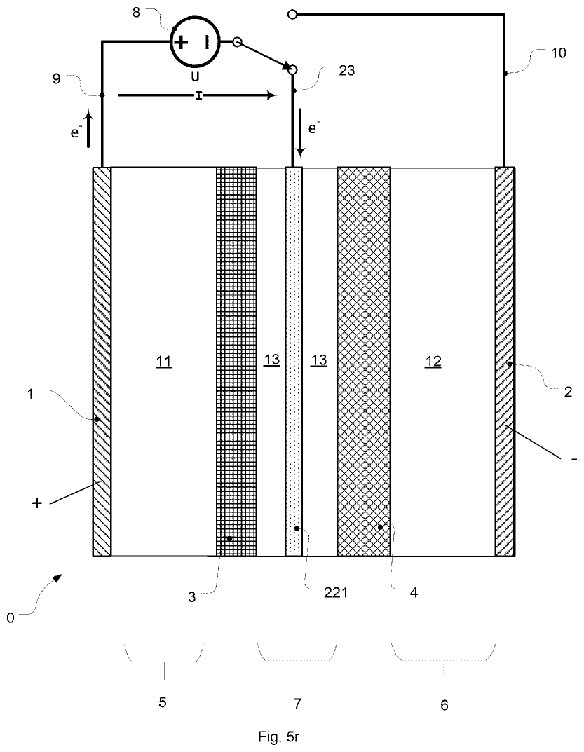

FIG. 4: shows water electrolysis in operation;

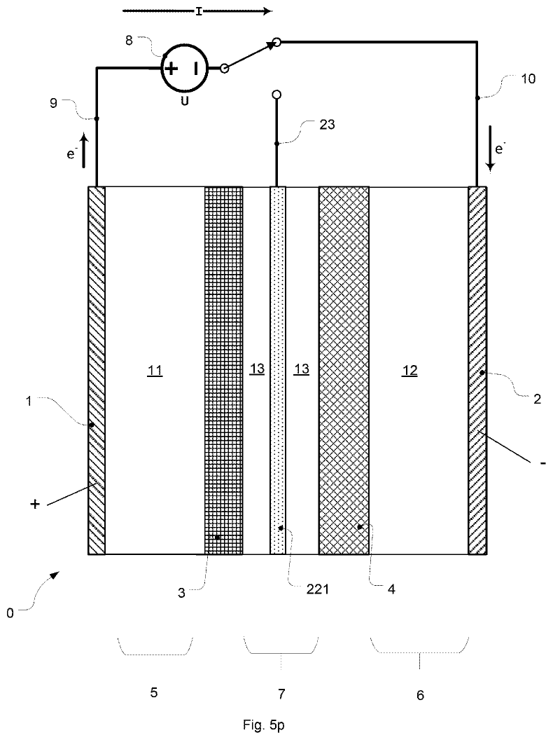

FIG. 5p: shows a three-chamber cell with a full-area auxiliary cathode in production operation;

FIG. 5r: shows a three-chamber cell with a full-area auxiliary cathode in regeneration operation;

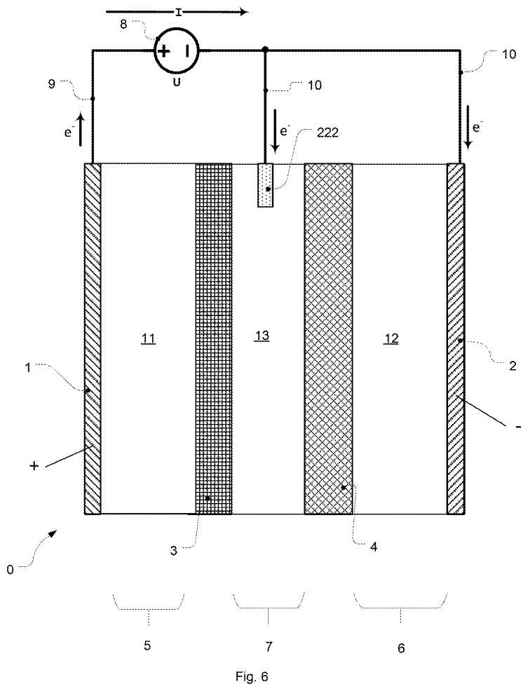

FIG. 6: shows a three-chamber cell with a reduced auxiliary cathode in combined operation;

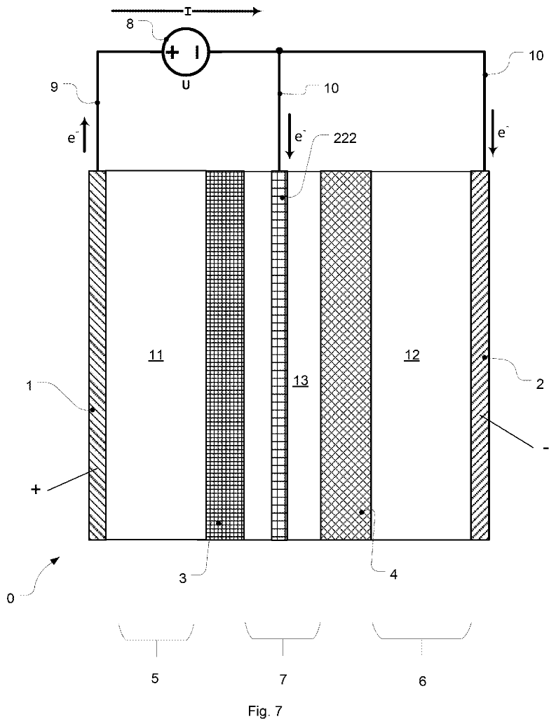

FIG. 7: shows a three-chamber cell with a perforated auxiliary cathode in combined operation;

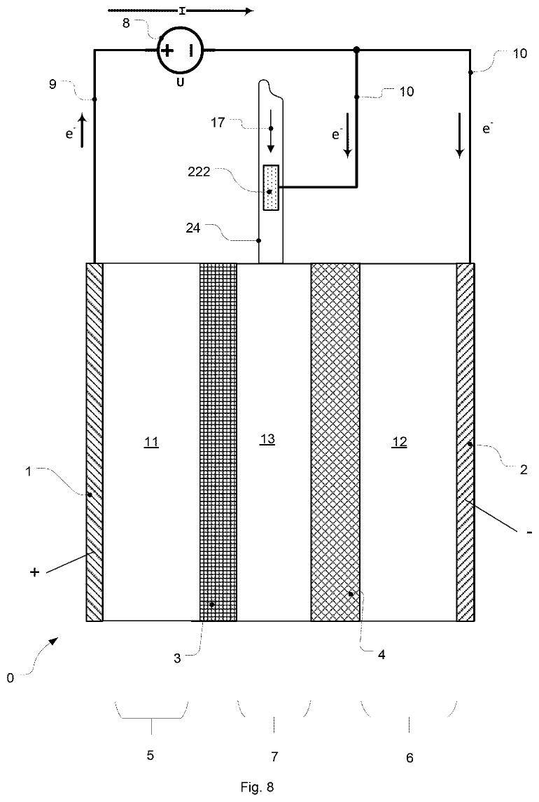

FIG. 8: shows a three-chamber cell with an upstream auxiliary cathode in combined operation.

FIG. 1 shows the basic construction of an electrochemical three-chamber cell, as is operated in the process according to the invention.

The electrochemical cell 0 comprises two electrodes, namely an anode 1 and a cathode 2. Arranged between the anode 1 and cathode 2 are two separators, namely an anode separator 3 and a cathode separator 4. The anode separator 3 is closer to the anode 1 than the cathode separator 4, while the cathode separator 4 is closer to the cathode 2 than the anode separator 3. There are three compartments 5, 6, 7 within the electrochemical cell 0 between the electrodes 1, 2 and separators 3, 4, for which reason it is also referred to as a three-chamber cell. The first compartment 5 extends between the anode 1 and the anode separator 3 and is therefore referred to as the anodic compartment 5. The second compartment 6 extends analogously between the cathode separator 4 and the cathode 2 and is therefore referred to as the cathodic compartment 6. The third compartment 7 is in the middle of the electrochemical cell 0 and is accordingly referred to as the central compartment 7. The central compartment 7 is delimited on the one side by the anode separator 3 and on the other side by the cathode separator 4.

The materiality of the separators 3, 4 is important: the anode separator 3 must have a conductivity for anions. If the anode separator 3 also has a conductivity for cations, the conductivity for cations should be lower than that for anions. This is the case for most anion-conducting materials. Suitable anion-conducting materials are of organic nature. Examples are polymers having a backbone to which at least one cationic functional group is bonded. The cationic functional group enables intrinsic transport of the anions, particularly of hydroxide ions (OH⁻), through the anode separator 3, while cations such as protons (H⁺) are barely able to cross the anode separator 3. The cathode separator 4 is configured the other way around: it has a higher conductivity for cations than for anions. Furthermore, the cation conductivity of the cathode separator 4 is selective: The conductivity for Li cations (Li+) must be greater than for other cations such as Ca+ or Na+. This has the result that Li cations preferentially pass through the cathode separator 4, while other cations are transported at least more slowly or even not at all. The cathode separator 4 is practically impermeable to anions. Suitable materials having these properties are inorganic LiSICons, that is to say a specific type of (glass) ceramic with an intrinsic conductivity for Li ions. At least one of the two separators 3, 4 must be electrically insulating. This is the case for inorganic LiSICons. If an inorganic LiSICon is used as cathode separator, the electrical conductivity of the organic anode separator 1 is of lesser importance. Preference is given, however, to using an organic anode separator which likewise has low electrical conductivity.

Specifically, the specific conductivity for electrons γ (electrical conductivity) of the electrically insulating separator at a temperature of 23° C. should be less than 10⁻⁷ S/cm (10⁻⁹ S/m) or less than 10⁻¹² S/m or less than 10⁻¹⁶ S/m. Such values are typical for inorganic materials, from an electron-conducting point of view, they can be qualified as nonconductors. The LiSICons described have specific conductivities of this magnitude and can therefore be regarded as electrical insulators. lonomers used as anode separator do not always achieve these specific conductivities. The cathode separator is therefore preferably used as electrical insulator. The specific conductivity for electrons γ is measured by impedance spectroscopy, as described above for the ion conductivity.

The electrical conductivity of at least one of the two separators 3, 4 is significant because the two electrodes 1, 2 need to be electrically insulated from one another. This prevents an electrical short circuit from occurring within the electrochemical cell 0 when an electrical voltage U is applied to the electrodes 1, 2. To apply such a voltage U, an electrical voltage source 8 is provided which can be connected in an electrically conducting manner to the anode 1 and to the cathode 2 via a first electrical lead 9 and a second electrical lead 10 respectively. The interconnection is selected such that the positive pole (+) of the electrical voltage source 8 is connected to the anode 1, while the negative pole (−) is connected to the cathode 2. Consequently, when the voltage source 8 is switched on the cathode 2 is negatively charged while the anode 1 is positively charged. The switching of the voltage source 8 and the level of the voltage U is explained in more detail below.

In addition to the previously described solid components of the electrochemical cell 0, said cell also comprises flowable elements in the form of three electrolytes 11, 12, 13. The first electrolyte 11 is in the first, anodic compartment 5 and is accordingly referred to as anolyte 11. The second electrolyte 12 is in the second, cathodic compartment 6 and is analogously referred to as catholyte 12. The central electrolyte 13 is arranged in the central compartment 7. All electrolytes 11, 12, 13 are flowable but not necessarily completely liquid. They may be multiphase mixtures having a liquid, a solid and a gas phase. All three electrolytes contain at least liquid water, however. The precise composition of the individual electrolytes 11, 12, 13 is explained below. It is important to understand that the compositions of the anolyte, catholyte and central electrolyte are constantly changing during the ongoing operation of the electrochemical cell 0.

Furthermore, the three electrolytes 11, 12, 13 may preferably be replaced continuously so that a steady flow process occurs through the three compartments 5, 6, 7 of the electrochemical cell 0 despite the changing composition. This is shown in FIG. 2 on the basis of a schematic setup of an apparatus 14.

Within the apparatus 14, the electrochemical cell 0 is divided into two circuits 15, 16, namely into an anodic circuit 15 and a cathodic circuit 16. In the anodic circuit 15 the anolyte 11 circulates through the anodic compartment 5, while the catholyte 12 circulates through the cathodic compartment 6. The central electrolyte 13 does not circulate but rather flows through the central compartment 7 only once in a straight passage 17.

Unlike what is shown in FIG. 2, it is also possible to allow the central electrolyte 13 to circulate through the central compartment 7. A large buffer vessel for the central electrolyte is necessary to this end, from which the central compartment 7 is supplied with central electrolyte. The central electrolyte withdrawn from the central compartment 7 is recycled into the buffer vessel. During operation, the Li concentration in this central circuit would continue to fall until a “limit concentration” is reached. Thereafter, the entire contents of this buffer vessel would be replaced and the next batch would be processed and the lithium separated off.

With respect to the circulation shown in FIG. 2 of the anolyte 11 and catholyte 12, it should be pointed out that these two electrolytes 11, 12 are continuously provided, namely in their respective circuit 15, 16. The central electrolyte 13 is also continuously provided in the apparatus 14 shown in FIG. 2, but in the straight passage 17. Alternatively, it would be conceivable to not allow all three electrolytes 11, 12, 13 to flow and to accordingly provide them only once in their respective compartment 5, 6, 7. This would be a batch process, which is not preferred. Also conceivable is a mixed continuous/batch operation, in which for instance the anolyte 11 and catholyte 12 continuously circulate, while the central electrolyte is introduced only once as a batch in the central compartment 7. It is likewise conceivable to provide only the catholyte 12 as a batch and to continuously replace the anolyte 11 and central electrolyte 13.

Thus, if reference is made herein to a provision of the electrolytes, this encompasses both the one-off provision (batch) and the continuous provision in the circuit 15, 16 or in the straight passage 17. The operation according to the invention of the electrochemical cell also includes mixed forms of one-off and continuous provision (continuous/batch operation) of the electrolytes 11, 12, 13.

The operation according to the invention of the electrochemical cell 0 serves for the processing of lithium-containing waters. The apparatus 14 shown in FIG. 2 is consequently an apparatus for processing lithium-containing waters. The lithium-containing water is fed into the central compartment 7 as fresh water 18. From a process-related point of view, the fresh water 18 can be regarded as a feed. When the voltage U is switched on, various electrochemical processes take place within the electrochemical cell 0, which are explained in more detail below. These processes have the result that the lithium present in the fresh water 18, more precisely the lithium cations Li⁺ dissolved therein, are depleted from the fresh water 18 and enriched in the catholyte 12. In the course of the depletion of the lithium from the fresh water 18, the latter becomes a wastewater 19, which is withdrawn from the central compartment 7. The Li concentration in the wastewater 19 is therefore lower than the Li concentration in the fresh water 18. The wastewater 19 is therefore rather low in lithium. From an electrochemical point of view, both the fresh water 18 and the wastewater 19 can be regarded as central electrolyte 13. The transition of the fresh water 18 into the wastewater 19 by way of the depletion of the lithium can be regarded and understood as the already discussed change in the composition of the electrolytes during the operation of the cell. The composition of the anolyte 11 and of the catholyte 12 also changes as a result of the electrochemical processes:

Li is enriched in the catholyte 12, with the result that the concentration of lithium in the catholyte 12⁺ withdrawn from the cathodic compartment 6 is greater than in the catholyte 12⁻ fed into the cathodic compartment 6. The withdrawn catholyte 12⁺ is rich in lithium, while the fed-in catholyte 12⁻ is low in lithium. In order to enable the circulation of the catholyte 12, a primary separation apparatus 20 is integrated into the cathodic circuit 16 which separates off the desired lithium compound, namely lithium hydroxide LiOH or lithium hydroxide monohydrate (LiOH·H₂O), from the lithium-rich catholyte 12⁺, with the result that low-lithium catholyte 12⁻ is left behind and recycled into the cathodic compartment 6. From a process-related point of view, the lithium hydroxide (monohydrate) separated off represents the target product of the process.

Analogously, a secondary separation apparatus 21 is integrated into the anolytic circuit 15 which serves to discharge from the process unwanted anions Xⁿ⁻ present in the fresh water 18. The unwanted anions Xⁿ⁻ are for example sulfates or chlorides or other mono- or polyvalent negatively charged ions. These ions originate from salts dissolved in the fresh water 18. In order to ensure that the charge balance remains the same and to prevent the occurrence of a concentration of anions in the central electrolyte or even unwanted anode reactions such as to form chlorine gas (Cl₂), these anions are depleted from the central electrolyte 13 and enriched in the anolyte 11. The concentration of these anions Xⁿ⁻ therefore increases in the anolyte 11, with the result that the concentration of anions Xⁿ⁻ in the anolyte 11⁺ withdrawn from the anodic compartment is greater than in the supplied anolyte 11⁻. The withdrawn anolyte 11⁺ is therefore rich in these anions, while the supplied anolyte 11⁻ is low in anions. The precise process of how the anions are enriched in the anolyte is explained below. However, it is important to mention that the anions Xⁿ⁻ in the anolyte 11 can combine to form other substances, especially acids, salts or molecular gases, depending on the composition of the anolyte. The anions can therefore also be separated off by the secondary separation apparatus 21 as part of such a compound. If these compounds are harmless, the withdrawn anolyte 11⁺ can also be disposed of as second wastewater. The anolytic circuit 15 is omitted in this case; the secondary separation apparatus 21 would be dispensable.

If a useful acid such as sulfuric acid H₂SO₄ or hydrochloric acid HCl is formed in an anode reaction, the withdrawn anolyte 11⁺ can also be used for the treatment of black mass: black mass is a mixture that is formed in the disintegration of used LIBs. In addition to lithium, it also contains the electrode materials Ni, Mn, Co, Al, Fe and graphite that can typically be found in LIBs, and copper as conductor material. Metals contained in the black mass can be dissolved using the acids mentioned. It would therefore be possible to use an acid-containing, withdrawn anolyte 11⁺ in upstream process stages of LIB processing.

As already mentioned, various electrochemical processes take place simultaneously in the operation according to the invention of the electrochemical cell 0. Precisely which processes take place depends on the precise composition of the electrolytes 11, 12, 13. In any case, however, a membrane-supported electrodialysis of the ions present and an electrolysis of water simultaneously take place. For a better understanding, both processes are now explained separately: the electrodialysis on the basis of FIG. 3 and the electrolysis on the basis on FIG. 4.

The electrodialysis shown in FIG. 3 serves on the one hand to enrich the Li cations Li⁺ present in the central electrolyte 13 in the catholyte 12. Furthermore, the unwanted anions Xⁿ⁻ present in the central electrolyte 13 and originating from the fresh water 18 are electrodialytically enriched in the anolyte 11 in order to prevent these anions from coming into contact with the cathode separator 4. In this way, the cathode separator 4 is protected from being poisoned by the anions Xⁿ⁻ and by products of the anode reaction. In addition, the depletion of the anions Xⁿ⁻ from the central electrolyte 13 reduces the formation of unwanted compounds of these anions with the free Li cations. This increases the yield of the target compound lithium hydroxide LiOH.

The electrodialysis shown in FIG. 3 and described here is made possible by the specific ion conductivity of the separator materials used and is driven by the applied electrical voltage U. The polarity of the electrical voltage source 8 is selected such that the cathode 2 is negatively charged while the anode 1 is positively charged. According to the generally recognized models of electrochemistry, the negatively charged anions migrate in the direction of the anode 1, whereas the positively charged cations are drawn in the opposite direction to the cathode 2. To balance the charge, an electrical current/flows along the electrical leads 9, 10 from the anode 1 to the cathode 2.

The anions Xⁿ⁻ and OH⁻ are able to pass from the central electrolyte 13 into the anolyte 11 because the anode separator 3 that lies in the way has an intrinsic anion conductivity. Since the central electrolyte 13 usually has a lower concentration of hydroxide ions OH⁻ than other anions, it is primarily non-hydroxide ions that migrate through the anode separator 3. Vice versa, the Li cations Li⁺ pass from the central compartment 7 into the catholyte 12 on account of the intrinsic lithium ion conductivity of the cathode separator 4. Since the cathode separator 4 consists of a material having a higher conductivity for Li cations than for other cations, other mono- or polyvalent metal cations Me^{m+} present in the fresh water 18 as impurities are barely able to leave the central electrolyte 13 in the direction of the catholyte 12, even though they are also striving for the cathode 2 on account of their positive charge. Only a small proportion of the cationic impurities Me^{m+} manages to cross the cathode separator 4 and form unwanted byproducts in the catholyte 12 (not shown). The majority of the cationic impurities Me^{m+} remain in the central electrolyte 13 and are discharged from the process with the wastewater 19. Owing to the specific cation selectivity of the cathode separator 4 in favour of lithium, the purity of the target product LiOH/LiOH·H₂O is increased and the current yield of the process is improved, since barely any electrical energy is wasted to transport the cationic impurities Me^{m+} from the central compartment 7 into the cathodic compartment 6.

The electrochemical splitting (electrolysis) of water H₂O into hydrogen H₂ and oxygen O₂ shown in FIG. 4 is effected in the process according to the invention in parallel with the electrodialysis shown in FIG. 3. More precisely, two water splitting operations are practised in parallel here, namely basic water splitting as per Equation (1) in the catholyte and acidic water splitting as per Equation (2) in the anolyte.

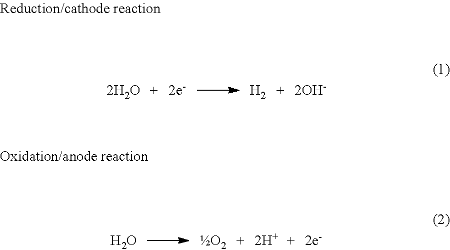

In the present process, the electrochemical cell 0 is filled with a basic water-based electrolyte and a voltage is applied between the anode 1 and cathode 2. The basic electrolytes in the present case are the central electrolyte 13 and the catholyte 12. It must therefore be ensured that the central electrolyte 13 and catholyte 12 are provided in the alkaline range. Since the starting materials used as electrolyte may be acidic depending on their origin, these electrolytes also have to be basified. The corresponding alkaline, lithium-containing water is correspondingly fed into the central compartment 7 as fresh water 18. The alkalinity of the catholyte 12 is preferably ensured by a minimum amount of lithium hydroxide dissolved in the catholyte 12. The hydroxide ions OH⁻ originating from the LiOH cause the alkalinity of the catholyte 12. The minimum amount of LiOH is ensured by operating the primary separation apparatus 20 such that the LiOH is not completely removed from the cathodic circuit 17. To start the process, a starting dose of LiOH is added to the catholyte 12.

On the cathode side of the three-chamber cell, that is to say in the central electrolyte 13 and in the catholyte 12, the water H₂O is broken down into hydrogen H₂ and hydroxide ions OH⁻ (Equation 1). The anode separator 3 primarily transports anions Xⁿ⁻ into the anodic compartment 5, where they can be oxidized to form corresponding compounds such as chlorine in the case of chloride ions. In addition, water H₂O is oxidized at the anode 1 and protons H⁺ and oxygen O₂ are formed (Equation 2). In this way, oxygen O₂ is formed on the anode side, while hydrogen H₂ is formed on the cathode side. At the anode, the corresponding acids of the anions, for instance hydrochloric acid or sulfuric acid, each in dissociated form, are also formed from the protons.

Furthermore, the presence of the hydroxide ions OH⁻ in the catholyte 12 has the result that they combine with the Li cations Li⁻ present in said catholyte to form lithium hydroxide LiOH (Equation 3).

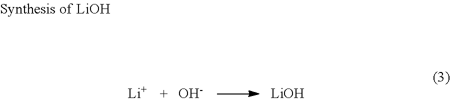

The LiOH is initially in dissolved form, that is to say as Li⁺ cations and hydroxide ions OH⁻. As soon as the concentration of these ions reaches the saturation limit, solid lithium hydroxide (LiOH) or lithium hydroxide monohydrate (LiOH·H₂O) precipitates, the target product of the process.

The target product is obtained from the catholyte 12 by way of the primary separation apparatus 20. Hydrogen H₂ and oxygen O₂ are byproducts. Because they are in gas form, the two byproducts easily escape from the catholyte 12 and the anolyte 11 and can accordingly be collected and used. A separation apparatus for the byproduct hydrogen H₂ or oxygen O₂ is not absolutely necessary, but conceivable.

To understand the entire process, it is important to recognize that the Li cations Li⁺ that form the LiOH in the catholyte 12 have only entered the catholyte 12 by means of the membrane-supported electrodialysis (FIG. 3). The hydroxide ions OH⁻, which combine in the catholyte 12 as per Equation 3 with the Li cations Li⁺ that have migrated in, are instead formed in the catholyte 12, namely by way of the cathode reaction of water splitting as per Equation 1 (FIG. 4). The operation according to the invention of the electrochemical cell 0 is thus based on the simultaneous performance of the water electrolysis and the membrane-supported electrodialysis.

In a particular embodiment of the operation according to the invention, the electrochemical cell is operated with an auxiliary cathode. FIGS. 5p, 5r, 6, 7 and 8 each show a configuration of a three-chamber cell with an auxiliary cathode. In FIGS. 5p and 5r said cathode is a full-area auxiliary cathode 221, and in each of FIGS. 6, 7 and 8 it is a reduced auxiliary cathode 222. In all cases, the auxiliary cathode 221/222 is in contact with the central electrolyte 13.

The auxiliary cathode 221 shown in FIGS. 5p, 5r has the same area as the two other electrodes 1, 2. The auxiliary cathode 221 can be connected to the negative pole of the voltage source 8 via a third electrical lead 23 (FIG. 5r). The connection between the negative pole of the voltage source 8 and the cathode 2 via the second electrical lead 10 is then interrupted so that the current I flows between the anode and auxiliary cathode 221. In this operating state shown in FIG. 5r, the electrochemical cell 0 is in regeneration operation. In regeneration operation, hydroxide ions OH⁻ are formed at the auxiliary cathode 221 according to Equation (1). These ions capture protons H⁺ through formation of a water molecule H₂O. The pH in the central electrolyte 13 is increased in this way, in order to operate in the desired basic range of pH 9 to 10.5. The regeneration operation is always implemented when the pH has fallen to an undesirable, acidic value of below 8. The pH is adjusted very quickly by way of the auxiliary electrode 221: The regeneration operation only has to be about 1/100 of the time of the production operation. It is thus not necessary to add basic compounds into the central electrolyte 13.

After completion of the regeneration (FIG. 5r), there is a switch back into the production operation (FIG. 5p). In this, the negative pole of the electrical voltage source 8 is connected to the cathode 2 via the second electrical lead 10. The current I flows between the anode 1 and cathode 2. The auxiliary cathode 221 is de-energized.

Instead of there being an alternating change between production and regeneration, it is also possible to continuously raise the pH using a reduced auxiliary electrode 222 that is likewise contacted with the central electrolyte 13 (FIG. 6). The area of the auxiliary electrode 222 is smaller than that of the two other electrodes 1, 2, for example about only 1/100. The auxiliary electrode 222 is permanently connected to the negative pole of the electrical voltage source 8 via the second electrical lead 10; the second electrical lead 10 is correspondingly branched. The current I therefore permanently flows between the anode 2 and the auxiliary cathode 222 and cathode 2. Due to the smaller area of the auxiliary cathode 222, only a small amount of hydroxide ions OH⁻ are formed in the central electrolyte 13, enough to keep the pH constant in the desired basic range of 9 to 10.5. It is then not necessary to add basic substances. The permanent operation with the reduced auxiliary cathode 222 can be regarded as a combined regeneration/production state.

A particular advantage of the reduced auxiliary cathode 222 is that it can also be placed outside of the electrochemical cell 0 for instance in the supply line of the central electrolyte 13. This saves space in the central compartment 7. A corresponding embodiment is shown in FIG. 8.

In addition, it is also possible to allow the reduced auxiliary cathode 222 to alternate between a pure production state and a combined regeneration/production state. This is a mixture of the operating states shown in FIGS. 5p, 5r and 6. This enables more flexibility when determining the area of the reduced auxiliary cathode 222 and the cycle times. This mixed operation is not portrayed.

FIG. 7 shows a further embodiment of an electrochemical cell 0 with a reduced auxiliary cathode 222. The reduction of the auxiliary cathode 222 is realized by using a porous textile as the auxiliary cathode, for instance a mesh fabric. Its porosity means that the auxiliary cathode 222 has a surface area A_{AK} smaller than the surface area A_{K} of the cathode 2. This is not directly apparent in FIG. 7 because the textile auxiliary cathode 222 extends through the entire central compartment 7. The advantage of using a textile auxiliary cathode is that it has better permeability for the ions than a full-area auxiliary cathode and therefore interferes to a lesser extent in the ion exchange.

FIG. 8 also shows a further embodiment of an electrochemical cell 0 with a reduced auxiliary cathode 222. Here, the auxiliary cathode 222 is arranged outside of the central compartment 7, more precisely in a supply line 24 for the central electrolyte 13. The central electrolyte 13 flows in the straight passage 17 through the supply line 24 into the central compartment 7 and leaves this again (not shown). The advantage of arranging the auxiliary cathode 222 in the supply line 24 is that the ions can move in the central compartment 7 unhindered by the auxiliary cathode 222. The contact of the auxiliary cathode 222 with the central electrolyte 13 within the supply line 24 is sufficient.

### EXAMPLES

The advantages achieved by the process regime according to the invention are now to be proven using experimental data:

### Experimental Setup

The electrochemical cell 0 used for the performance of the experiments is shown in FIG. 8. It comprises three compartments 5, 6 and 7. The compartments 7 and 6 are separated by an ion-exchange membrane, what is known as the cathode separator 4. Compartment 5 and 7 are separated from one another by a membrane, what is known as the anode separator 3. Arranged in the first compartment 5 is an anode 1. In the central compartment 7, there is an auxiliary cathode 222 in the supply line for the central electrolyte 13. Arranged in the third compartment 6 is a cathode 2. The first compartment 5 can also be referred to as the anodic compartment, while the third compartment 6 can also be referred to as the cathodic compartment. The compartment 7 in the middle can also be referred to as the central compartment 7.

A first electrical lead 9 connects the anode 1 to a voltage source 8. A second electrical lead 10 connects the cathode 2 to the voltage source 8. A branch of the second electrical lead 10 connects the voltage source 8 to the auxiliary cathode 222. The polarity of the voltage source 8 is selected such that the positive pole of the voltage source 8 is connected to the anode 1, while the negative pole of the voltage source 8 is connected to the cathode 2 and the auxiliary cathode 222.

An electric current I flows through the electrical leads 9 and 10 and via the electrical voltage source 8. Since the ion-exchange membrane 4 is electrically insulating, there is no electrical short circuit between the two electrodes 1 and 2 via the ion-exchange membrane 4.

The ion-exchange membrane 4 is a flat-sheet membrane that consists entirely of an LiSICon material. The other membrane 3 is also a flat-sheet membrane; it is produced from an anion-conductive polymer, such as an AHA membrane, Eurodia Industrie SAS, or a Neosepta membrane from ASTOM.

The auxiliary cathode 222 is a wire, comprising titanium, platinum or stainless steel. The cathode 2 is likewise a flat metal plate comprising titanium or nickel. In the simplest case, stainless steel plate is used as the cathode. The anode 1, cathode 2 and the two membranes 3, 4 have the same shape; they may be rectangular or circular. The auxiliary cathode 222 is a wire, the area of which that protrudes into the supply line 24 for the central electrolyte 13 accounts for 2% of the active area A of the cathode 2. This is not shown to scale in the side view of FIG. 8. Instead of metal plates, it is also possible to use expanded metals, grids or meshes of the specified materials as electrodes.

The electrochemical cell 0 has an active area A which corresponds to the surface area of the two membranes 3, 4, the anode 1 and the cathode 2. As mentioned, the auxiliary cathode 222 is smaller; its active surface area is only 2/100*A.

During operation, the compartments 5 and 7 are charged with a feed 13. The compartments 5 and 7 can have the same feed 13, or a solution 11 different from 13 is in one of the chambers. The feed 13 is an aqueous solution containing Li+ cations. From an electrochemical point of view, the feed 13 can be regarded as anolyte.

The feed 13 may be an Li leach liquor from a natural deposit or a material stream arising from the processing of used LIBs. The concentration of Li+ cations in the feed 13 should be at least 200 ppm by weight, based on the total mass of the feed. Seawater has a lower Li concentration and must therefore first be concentrated before it is used in the process. The feed 13 also contains anions such as sulfate or chloride. The feed 13 also contains impurities. Anions and impurities are not shown in FIG. 1. The main component of the feed 13 is water.

The cathodic compartment 6 is charged with a poor working medium 12⁻. The poor working medium 12⁻ is water with a low concentration of Li+ cations. The concentration is at least 50 ppm by weight based on the total mass of the poor working medium 12⁻. From an electrochemical point of view, the poor working medium 12 can be regarded as catholyte.

In addition, an electrical voltage U obtained from the voltage source 8 is supplied to the electrochemical cell 0. This has the following effect:

Firstly, water electrolysis takes place in which water is electrochemically split into hydrogen and oxygen. OH— and hydrogen are formed at the cathode 2 and the auxiliary cathode 222. The OH— anions are however unable to cross the LiSICon membrane 4 and combine with the Li⁺ cations present in the cathodic compartment 6 to form lithium hydroxide. Oxygen and H⁺ are formed at the anode 1. In the central compartment 7 (that having the auxiliary cathode 222), OH— anions are formed which keep the pH in the compartment 7 stable.

The formation of the LiOH in the cathodic compartment 6 is maintained by the migration in the direction of the cathode 2 of Li+ cations from the feed 13 driven by the voltage U. They cross the LiSICon membrane 4 due to the conductivity of said membrane for Li ions and accumulate in the working medium 12 (membrane electrolysis). This results in the formation of a rich working medium 12⁺, which is withdrawn from the cathodic compartment 6. The concentration of Li+ ions in the rich working medium 12′ is greater than in the poor working medium 12⁻.

Thus, a water electrolysis, a membrane electrolysis of Li⁺ and a synthesis of LiOH proceed simultaneously in the electrochemical cell 0.

The simultaneous operation of the Li+ membrane electrolysis and the water electrolysis in the electrochemical cell thus results in the direct formation of lithium hydroxide LiOH and molecular hydrogen H₂. The hydrogen is at least partly dissolved, it may also be present in the form of gas bubbles. Depending on the temperature and on the presence of crystallization seeds, the LiOH precipitates already in the cathodic compartment 6 or immediately after withdrawal of the rich working medium 12⁺.

The feed 13 becomes depleted in Li+ as a result of the membrane electrolysis, giving rise to wastewater 19.

### Experimental Procedure

To perform the electrolysis, the electrolytes are first filled into the two anolyte and catholyte containers and the supply hoses are disconnected. The electrolyte container which supplies the part of the cell that is directly at the membrane is referred to hereinafter as the central compartment. The electrolysis cell is assembled in the next step. During the assembly, the membranes should be prevented from drying out by carrying out the procedure quickly. Once the electrolysis cell has been assembled, it is connected to the anolyte and catholyte containers and to the middle chamber. Care is taken to ensure here that the inflow and return flow are in each case connected on the same side. The supply lines to the cell can then carefully be opened; the supply hoses for the catholyte and middle chamber should be opened at the same time here.

The anode and cathode used were in each case a round disc having a diameter of 19.5 mm and a thickness of 1 mm. The material was in each case a titanium expanded metal plate, coated on both sides with IrTi mixed oxide, 12 g Ir/m², 1 AF D 1.5 mm from Metakem GmbH, 61250 Usingen, Germany.

The auxiliary cathode used was a wire having a thickness of 2 mm which protruded about 3 mm into the supply line of the central compartment. The material is a titanium wire, coated with IrTi mixed oxide, 12 g Ir/m2 from Metakem GmbH, 61250 Usingen, Germany.

The anode and cathode are connected to the voltage source, the Keithley 2400 potentiostat from Tektronix UK Ltd., Berkshire, UK. The auxiliary cathode is connected to the cathode.

The membranes sampled were likewise circular discs having a diameter of about 25 mm. The thickness of the membranes was about 1 mm. The material of the LiSICon membranes sampled was an Ampcera™ LISICON LAGP, from MSE Supplies®, Tucson, USA. The material of the organic anion-exchange membranes sampled was an AHA membrane, Eurodia Industrie SAS.

The electrolysis and the corresponding reservoir vessels are blanketed with nitrogen for the entire performance in order to prevent the formation of lithium carbonate. Each cell has a separate anolyte and catholyte container and a separate middle chamber. Each vessel is filled with about 1 kg of liquid; the exact mass is determined by reweighing. In all experiments, the catholyte at the beginning of the experiments was always a 5 mmol/1 LiOH solution (corresponding to 120 ppm by weight of LiOH). The anolyte and the electrolyte in the middle chamber are lithium salt solutions in different concentrations and with different lithium salts. The anolyte container and middle chamber may contain solutions that are different from one another. The starting concentrations and also the exact concentrations vary in the course of the experiment and are therefore each also shown in the diagram for the experiments.

On switching on the pumps and applying the desired voltage, the experiment commences. During the experiment, the voltage is applied cyclically, this is controlled by the correspondingly programmed Siemens LOGO! 230 RC control unit from Siemens.

The maximum flow rate is 900 ml/minute and is determined by means of a SONOFLOW CO.55/060 V2.0 ultrasound flow sensor from Sonotec. Samples are collected every half hour or at longer intervals if this has been agreed. The first 3 ml of sample collected is discarded. Each time a sample is taken, the respective current is noted and from the sample the pH and the conductivity are determined. The samples are then returned to the appropriate container so as to keep the volume virtually constant.

At the end of the experiment, the containers are emptied and all leads and also the membrane are rinsed with demineralized water. The cell is dismantled, the membrane is photographed and SEM images of the catholyte side and anolyte side are recorded in order to document any damage or changes to the membranes. The ion-exchange membrane is microscopically checked for any changes. The side facing the middle chamber and also the anolyte side are checked.

The membrane performance is measured by the parameters of permeability (g Li*mm/m²*h) and permeance (g Li/m²*h). The permeance indicates how much mass of lithium per unit membrane area and per unit time is being transported through the membrane. The permeability also takes account of the membrane thickness and thus also makes it possible to compare different membrane types having different thicknesses with one another. For a comprehensive description of the performance both are required, since extremely thin membranes would permit enormously high permeance, but if concentration polarization effects were present in the membrane cell the permeabilities would give an inaccurate picture. Taking account of the membrane thickness would then no longer serve any useful purpose, since transport would not be limited by the membrane.

All measured values shown in the examples are subject to a measurement error of approx. ±10% attributable to imprecision in the positioning of the electrodes with respect to one another, in the determinations of the thickness of the membrane samples, and in the determination of the concentration via conductivity measurements.

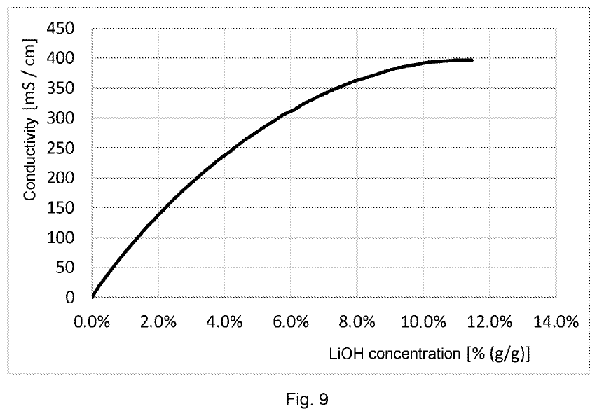

The concentration was determined inline via a conductivity measurement. In the experiment results, the conductivity is converted into a concentration via the calibration curve shown in FIG. 9.

FIG. 9: Conductivity as a function of the concentration of an LiOH solution (25° C.)

This does however mean that at concentrations above approx. 10% LiOH it is almost impossible to accurately monitor the actual concentration via conductivity measurements.

The variations within the experiments can be seen in Table 1.

### Table 1: Experiment Overview

Apart from these, the following, constant experiment conditions existed:
Cycle time: current on for 50 s—current off for 10 s
Concentration of catholyte: 5 mmol/1 LiOH—LiOH*H2O, 98%, Thermo Fisher Scientific
Voltage: 6 V (between anode and cathode, and between auxiliary cathode and anode)
Membrane: Ampcera® LISCON LAGP

TABLE 1

| | Qualification | | | |
|---|---|---|---|---|
| Experiment | of | Anion-exchange | | |
| no.: | experiment | membrane | Central electrolyte | Anolyte |
| 1a | inventive | AHA membrane | 1M LiCl ≥99%, | 1M LiCl ≥99%, |
| | | Eurodia Industrie SAS, | Carl Roth GmbH + Co. KG | Carl Roth GmbH + Co. KG |
| | | St Martin, FR | | |
| 1b | inventive | AHA membrane | 1M LiCl ≥99%, | 1M LiCl ≥99%, |
| | | Eurodia Industrie SAS, | Carl Roth GmbH + Co. KG | Carl Roth GmbH + Co. KG |
| | | St Martin, FR | | |
| 1c | inventive | AHA membrane | 1M LiCl ≥99%, | 1M LiCl ≥99%, |
| | | Eurodia Industrie SAS, | Carl Roth GmbH + Co. KG | Carl Roth GmbH + Co. KG |
| | | St Martin, FR | | |
| 2 | inventive | AHA membrane | 1.43M LiCl + | 1.43M LiCl + |
| | | | 0.0045M NaCl, ≥99%, | 0.0045M NaCl, ≥99%, |
| | | | Carl Roth GmbH + Co. KG | Carl Roth GmbH + Co. KG |
| 3 | inventive | AHA membrane | 1.43M LiCl + | 1.43M LiCl + |
| | | | 0.0045M NaF, | 0.0045M NaF, |
| | | | PanReac Applichem GmbH + | PanReac Applichem GmbH + |
| | | | 0.015M CaCl₂ ≥99%, | 0.015M CaCl₂ ≥99% |
| | | | Carl Roth GmbH + Co. KG | Carl Roth GmbH + Co. KG |
| 4 | inventive | AHA membrane | 0.72M Li₂SO₄, ≥99% | 0.72M Li₂SO₄, ≥99% |
| | | | Carl Roth GmbH + Co. KG + | Carl Roth GmbH + Co. KG + |
| | | | 0.004M Na₂SO₄ | 0.004M Na₂SO₄ |
| | | | Carl Roth GmbH + Co. KG | Carl Roth GmbH + Co. KG |
| 5 | inventive | AHA membrane | 9.4M LiCl ≥99%, | 9.4M LiCl ≥99%, |
| | | | Carl Roth GmbH + Co. KG | Carl Roth GmbH + Co. KG |
| 6 | inventive | AHA membrane | 9.4M LiCl + 0.043M NaCl + | 9.4M LiCl + 0.043M NaCl + |
| | | | 0.026M KCl, ≥99.5%, | 0.026M KCl, ≥99.5% |
| | | | Carl Roth GmbH + Co. KG | Carl Roth GmbH + Co. KG |

### Experiment 1a

The experiment was set up as already described above (experimental procedure and details as described in Tab 1).

An auxiliary cathode in the form of a stainless steel wire mesh (grade 1.4401) having a mesh width of 200 μm was placed in the central compartment and provided with a wire which enables electrical contact from the outside (cf. FIG. 7).

When the pumps for the three circuits are started up, the cyclically applied direct voltage of 6 V was simultaneously applied between the anode and cathode. Over the course of the experiment, the decrease in the pH of the middle chamber can be monitored by regularly talking samples. After about 24 h it fell from a pH of 9 to a value of 7.3. The pH of the anolyte after 24 h was 2.5, the current was about 30 mA.

After these 24 h, the auxiliary cathode was then exclusively operated at a voltage of 6 V for a total of five minutes. This results in a current of up to 200 mA during this period. The pH of the middle chamber increases to more than 10.

### Experiment 1b

In the case of a further operation of the cell under the same settings as Experiment 1a (Experiment 1b), now again without any voltage applied to the auxiliary cathode, the current through the cell increases to more than 70 mA, which is also associated with a correspondingly greater permeance.

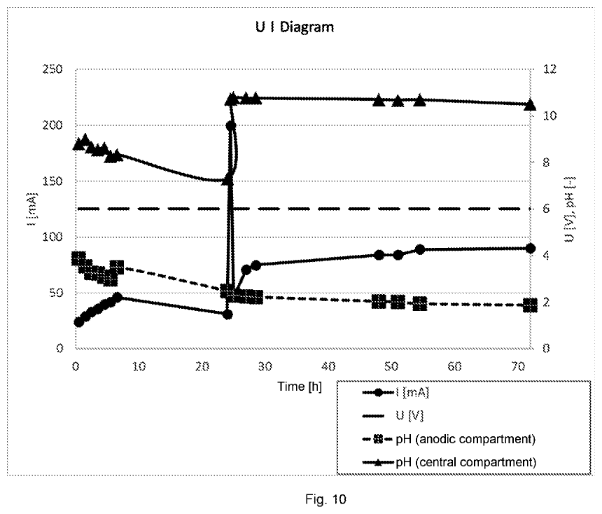

The course of the measurement points from Experiment 1a and 1b is shown in the diagram of FIG. 10.
FIG. 10: Diagram for Experiments 1a and 1b

For a simplified overview, all results/values are collated in Table 2.
Table 2: Measured values from the experiments

### Experiment 1c

Using the same measurement setup with the only difference that the auxiliary cathode was then designed not as a wire mesh, but as a wire in the feed line to the middle chamber having a surface area of 2% of the electrode and membrane area (FIG. 8). The results are also collated in Table 2.

### Experiments 2 to 6

These experiments were performed in a setup as was used in Experiment 1c. The voltage between the anode and cathode was 6 V and that between the auxiliary cathode and anode was also 6 V. Point measurements of the current at the auxiliary cathode gave values between 1% and 20% of the current that flowed between the anode and cathode. All results after an operating time of the cell of in each case 50 h are listed in Table 2.

TABLE 2

| | | | | | | pH | |
|---|---|---|---|---|---|---|---|
| Experiment | U | I | Permeance | Permeability | pH | Central | pH |
| no.: | [V] | [mA] | [g_{Li}/m² h] | [g_{Li} mm/m² h] | Anolyte | electrolyte | Catholyte |
| 1a | 6 | 30 | 27 | 8.5 | 2.5 | 7.3 | 12 |
| 1b | 6 | >70 | >35 | >12 | 2.0 | 11 | 12 |
| 1c | 6 | 78 | 43 | 12.8 | 2.1 | 9.5 | 12 |
| 2 | 6 | 80 | 42 | 12.6 | 2.6 | 10.2 | 12 |
| 3 | 6 | 75 | 39 | 11.7 | 2.6 | 10.1 | 12 |
| 4 | 6 | 60 | 30 | 8.9 | 2.0 | 9.5 | 12 |
| 5 | 6 | 60 | 33 | 11 | 1.0 | 7.3 | 12 |
| 6 | 6 | 64 | 45 | 13.6 | 0.2 | 7.6 | 12 |

### Comparative Experiments

For comparison, cells without an anion-exchange membrane were constructed. An overview is provided in Table 3.
Table 3: Comparative experiment overview

TABLE 3

| | Qualification | Anion- | |
|---|---|---|---|
| Experiment | of | exchange | Central electrolyte = |
| no.: | experiment | membrane | anolyte |
| 7 | not inventive | none | 1M LiCl ≥99%, |
| | | | Carl Roth GmbH + Co. KG |
| 8 | not inventive | none | 0.5M Li₂SO₄, ≥99% |
| | | | Carl Roth GmbH + Co. KG |

The measured values of the comparative experiments are recorded in Table 4.
Table 4: Measured values from comparative experiments

TABLE 4

| | | | | | | pH | |
|---|---|---|---|---|---|---|---|
| Experiment | U | I | Permeance | Permeability | pH | Central | pH |
| no.: | [V] | [mA] | [g_{Li}/m² h] | [g_{Li} mm/m² h] | Anolyte | electrolyte | Catholyte |
| 7 | 6 | 19 | 18 | 6 | 2.0 | 2.0 | 12 |
| 8 | 6 | 17 | 15 | 5 | 1.7 | 1.7 | 12 |

### Experiment 7

As a comparative experiment, the setup used in Experiments 1 to 6 was modified in such a way that the anion-exchange membrane between the central compartment and the anodic compartment was omitted, with the result that the cell has only two separate compartments, namely exactly one anodic compartment and exactly one cathodic compartment. An auxiliary cathode was not used.

Since the pH in the anodic compartment is reduced over the course of the experiment due to the proton formation at the anode, from a pH of less than 7 there is continuous damage to the ceramic LiSICon membrane. This means that the results specified in Table 4 are not constant achieved values, but rather they continue to reduce further and further over the duration of the experiment, especially after 5 to 50 h. By way of example, the data after approx. 24 h have been shown.

### Experiment 8

The same applies here as for Experiment 7, only with the difference that a lithium sulfate solution was used for the experiments.

### Conclusion

The experiments demonstrate that a higher permeance and permeability are maintained by the operation according to the invention of a three-chamber cell with an anion-exchange membrane as anode separator (Experiments 1a to 7) in comparison with a two-chamber cell (Experiments 8 and 9) after the same operating time. This means that, in the processing of lithium-containing waters, the same cathode separator is subject to greater wear when it is installed in a two-chamber cell than in a three-chamber cell. Consequently, higher efficiency can be expected in the operation according to the invention of the three-chamber cell over a long period of use.

In all experiments, the contents of foreign cations in the catholyte were below the detection limit. The purity of the target product was not negatively affected by cathodic impurities present in the central electrolyte, such as by sodium.

Furthermore, a higher current flows in the operation according to the invention of the cell (Experiments 1a to 7) than in the operation not according to the invention (Experiments 8 and 9). The productivity per unit area is therefore better. This has the result that an apparatus operated in this manner can be dimensioned so as to be smaller with the same production output.

The comparison of the operation with an auxiliary cathode configured as a wire mesh (Experiment 1) with that in which the auxiliary cathode was implemented in the supply line (Experiment 2 ff) shows that the implementation of the auxiliary cathode in the supply line leads during ongoing operation to a very good permeance, without having to regularly switch between the various operating states. This simplification in the design of the cell, as well as in the performance, shows that the arrangement of the auxiliary cathode in the supply line is the particularly preferred embodiment.

### LIST OF REFERENCE SYMBOLS

0 Electrochemical cell (three-chamber cell)
1 Anode
2 Cathode
3 Anode separator
4 Cathode separator
5 Anodic compartment
6 Cathodic compartment
7 Central compartment
8 Electrical voltage source
9 First electrical lead
10 Second electrical lead
11 Anolyte
11⁻ Anolyte fed in (low in anions)
11⁺ Anolyte withdrawn (rich in anions)
12 Catholyte
12⁻ Catholyte fed in (low in lithium)
12⁺ Catholyte withdrawn (rich in lithium)
13 Central electrolyte
14 Apparatus
15 Anodic circuit
16 Cathodic circuit
17 Straight passage
18 Fresh water (containing lithium)
19 Wastewater (low in lithium)
20 Primary separation apparatus
21 Secondary separation apparatus
221 Full-area auxiliary cathode
222 Reduced auxiliary cathode
23 Third electrical lead
24 Central electrolyte supply line
Xⁿ⁻ Anions
Me^{m+} Cationic impurities
OH⁻ Hydroxide ions
H⁺ Protons
Li⁺ Lithium cations
LiOH Lithium hydroxide
H₂ Hydrogen
O₂ Oxygen
H₂O Water

1. Process for operating an electrochemical cell, comprising the following, non-chronological steps:
a) providing at least the electrochemical cell having at least the following features:
i) the electrochemical cell comprises an anode and a cathode;
ii) the electrochemical cell comprises a cathode separator and an anode separator;
iii) the electrochemical cell comprises an anodic compartment, a central compartment and a cathodic compartment;
iv) the cathode separator separates the central compartment from the cathodic compartment;
v) the anode separator separates the central compartment from the anodic compartment;
vi) the cathode separator comprises an inorganic material having a conductivity for anions and a conductivity for cations, the conductivity for cations being greater than the conductivity for anions and the conductivity for Li cations (Li⁺) being greater than the conductivity for cationic impurities (Me^{m+});
vii) the anode separator comprises an organic material having a conductivity for anions (Xⁿ⁻, OH⁻) and a conductivity for cations, the conductivity for anions (Xⁿ⁻, OH⁻) being greater than the conductivity for cations;
viii) the inorganic material and/or the organic material is electrically insulating;
b) providing a catholyte in the cathodic compartment, the catholyte comprising at least: water (H₂O), Li cations (Li⁺), hydroxide ions (OH⁻);
c) providing a central electrolyte in the central compartment, the central electrolyte comprising at least: water (H₂O), Li cations (Li⁺), anions (Xⁿ⁻) and cationic impurities (Me^{m+});
d) providing an anolyte in the anodic compartment, the anolyte comprising at least: water (H₂O) and anions (Xⁿ⁻);
e) providing at least one electrical voltage source which can be connected to the anode via a first electrical lead and to the cathode via a second electrical lead;
f) applying an electrical voltage U obtained from the electrical voltage source to the electrochemical cell such that an electrical current/flows between the anode and cathode.

2. Process according to claim 1, characterized in that at least some of the steps are performed simultaneously and continuously.

3. Process according to claim 1 or 2, characterized in that the central electrolyte additionally also comprises hydroxide ions (OH⁻), and in that the pH of the central electrolyte is between 9 and 12, measured using a glass electrode at a temperature of 25° C.

4. Process according to any of claims 1 to 3, characterized in that the anions (Xⁿ⁻) are selected from the group consisting of sulfate, hydrogensulfate, carbonate, hydrogencarbonate, hydroxide, chloride and fluoride.

5. Process according to claim 4, characterized in that the central electrolyte has a higher concentration of the anions (Xⁿ⁻) selected from said group than hydroxide ions (OH⁻).

6. Process according to any of claims 1 to 5, characterized in that the cationic impurities (Me^{m+}) are cations of elements selected from the group consisting of B, Na, Mg, Al, Si, K, Ca, Mn, Fe, Co, Ni, Cu and C.

7. Process according to any of the preceding claims, where the inorganic material present in the cathode separator has a specific conductivity for Li cations σ, measured by the “impedance spectroscopy” method described herein, that at a temperature of 23° C. is at least 1*10⁻⁵ S/cm or at least 5*10⁻⁵ S/cm or at least 10*10⁻⁵ S/cm and at most 100*10⁻⁵ S/cm.

8. Process according to claim 7, characterized in that the inorganic material is a compound of the following stoichiometry (LATP): 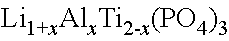
in which: 0.1×0.3, where preferably x=0.3.

9. Process according to claim 7, characterized in that the inorganic material is a compound of the following stoichiometry (LATSP): 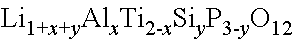
in which: 0.1≤x≤0.3 and 0.2≤y≤0.4.

10. Process according to claim 7, characterized in that the inorganic material is a compound of the following stoichiometry (LAGTSP): 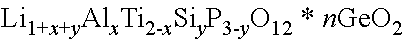
in which: 0≤x≤1 and 0≤y≤1 and 0≤n≤1.

11. Process according to claim 7, characterized in that the inorganic material is a compound of the following stoichiometry (LAGTP): 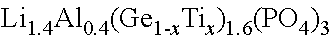
in which: 0≤x≤1.

12. Process according to claim 7, characterized in that the inorganic material is a compound of the following stoichiometry (LAGP): 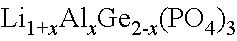
in which: x=0 or x=0.2 or x=0.4.

13. Process according to claim 7, characterized in that the inorganic material is a compound of the following stoichiometry (LLTO): 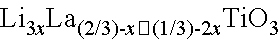
in which: 0≤x≤0.16.

14. Process according to claim 7, characterized in that the inorganic material is a compound of the following stoichiometry (doped LLZO): 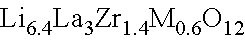
where M is selected from the group consisting of the following elements: Ta, Sb, Nb.

15. Process according to claim 7, characterized in that the inorganic material is a compound of the following stoichiometry (LLZO):

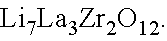

16. Process according to any of claims 1 to 15, characterized in that the organic material present in the anode separator is a polymer having a backbone to which at least one cationic functional group is bonded.

17. Process according to claim 16, characterized in that the cationic functional group is a quaternized trialkylammonium salt.

18. Process according to claim 16 or 17, characterized in that the backbone is selected from the group consisting of polystyrene, polysulfone, poly(ethersulfone) or poly(phenylene oxide), polyvinylidene fluoride, or polytetrafluoroethylene.

19. Process according to claim 16, characterized in that the cationic functional group is a quaternized trialkylammonium salt, in that the backbone is selected from the group consisting of polystyrene, polysulfone, poly(ethersulfone) or poly(phenylene oxide), and in that the quaternized trialkylammonium salt is attached to the backbone via a benzyl(methyl) group.

20. Process according to any of the preceding claims 1 to 19, characterized in that an electrochemical cell additionally having the following features is provided:
ix) the electrochemical cell comprises an auxiliary cathode;
x) the auxiliary cathode is in contact with the central electrolyte;
xi) the auxiliary cathode can be connected to the electrical voltage source via a third electrical lead.

21. Process according to claim 20, characterized in that the process has two operating states, namely:
p) a production state in which the anode and the cathode are connected to the electrical voltage source via the first and the second electrical lead, respectively, and in which the electrical voltage U is applied to the anode and cathode so that the electrical current l flows between the anode and cathode;
r) a regeneration state in which the anode and the auxiliary cathode are connected to the electrical voltage source via the first and the third electrical lead, respectively, and in which the electrical voltage U is applied to the anode and auxiliary cathode so that the electrical current/flows between the anode and auxiliary cathode.

22. Process according to claim 21, characterized by an alternating change between production state (p) and regeneration state (r), where an individual production state is carried out over a duration of t_{P} and where an individual regeneration state is carried out over a duration of t_{R}, where 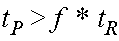
where f is greater than 1 or where f is greater than 10 or where f is greater than 100.

23. Process according to claim 20, characterized in that an electrochemical cell additionally having the following features is provided:
xii) the cathode has a cathode area A_{K};
xiii) the auxiliary cathode has an auxiliary cathode area A_{AK};
and in that the process has one operating state, namely:
k) a combined production and regeneration state in which the anode is connected to the electrical voltage source via the first electrical lead and the cathode and the auxiliary cathode are connected to the electrical voltage source via the second electrical lead and in which the electrical voltage U is applied to the anode and cathode and auxiliary cathode so that the electrical current/flows between the anode and cathode and auxiliary cathode;
where the cathode area A_{K} and the auxiliary cathode area A_{AK} are selected such that 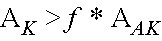
where f is greater than 1 or where f is greater than 10 or where f is greater than 100.

24. Process according to claim 23, characterized in that the process has two operating states, namely:
k) the combined production and regeneration state,
p) a production state in which the anode and the cathode are connected to the electrical voltage source via the first and the second electrical lead, respectively, and in which the electrical voltage U is applied to the anode and cathode so that the electrical current I flows between the anode and cathode;
there being an alternating change between the production state (p) and the combined production and regeneration state (k), where an individual production state (p) is carried out over a duration of t_{P} and where an individual combined production and regeneration state (k) is carried out over a duration of t_{K}, where 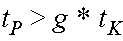
where g is greater than 50 or where g is greater than 500 or where g is greater than 5000.

25. Process according to either of the preceding claims 20 to 24, characterized in that the auxiliary electrode is arranged outside the central compartment and/or in that the auxiliary electrode consists of a textile material.

26. Process according to any of the preceding claims 1 to 25, characterized in that the operation involves an electrolysis of water (H₂O) and an electrodialysis of anions (Xⁿ⁻).

27. Process according to claim 26, characterized in that the operation involves the synthesis of lithium hydroxide and/or lithium hydroxide monohydrate (LiOH·H₂O).
